(19) United States
(12) Patent Application Publication
(10) Pub. No.: US 2005/0021382 A1
(43) Pub. Date: Jan. 27, 2005

(54) Organization profiling using characterizations of organizational processes by multiple members

(76) Inventor: Ted Margison, Los Angeles, CA (US)

Correspondence Address: Attn: Craig A. Gelfound;MCDERMOTT, WILL & EMERY, 34th Floor, 2049 Century Park East, Los Angeles, CA, 90067, US

(21) Appl. No.: 10/625,220

(22) Filed: Jul. 22, 2003

(51) Int. Cl. G06F 17/60

(52) U.S. Cl. 705/8

(57) ABSTRACT

A process for profiling an organization having members. The process may present to members a user interface to a database that contains a plurality of processes of the organization and, for each process, a plurality of selectable characterizations of the process. Selections from members may be received through the user interface of one or more characterizations of one or more of the processes. This may include selections of one or more characterizations of the same process by at least two members. The selections may be stored, compared, and a presentation concerning the comparisons may be made. The processes may be advantageously defined to facilitate a profiling of the business transactions of the organization, its infrastructure, or other aspects.

### BACKGROUND

Field

This application relates to organizational processes and, more particularly, to profiling of those processes.

Related Art

The processes employed by organizations, such as businesses, are often less than optimal. Accurately identifying the deficiencies, however, can frequently be challenging, particularly in large organizations.

Experts are often hired to analyze the processes of an organization and to report their findings. Unfortunately, the experts may not obtain an accurate understanding of the existing processes of the organization, particularly when those processes are numerous and complex. Any recommendations that are based on these inaccurate understandings can similarly be flawed.

### SUMMARY

A process for profiling an organization having members may include presenting a user interface to the members to a database that contains a plurality of processes of the organization and, for each process, a plurality of selectable characterizations of the process. Selections from members may be received through the user interface of one or more of the characterizations of one or more of the processes, including selections of one or more characterizations of the same process by at least two members. The selections of the characterizations made by the members may be stored, including the selections of one or more characterizations of the same process by at least two members, along with an identification of the members that made the selections. The selections made by the members may be compared, including the selections of one or more characterizations of the same process by at least two members. A presentation concerning the selections made by the members may be prepared, including the selections of one or more characterizations of the same process by at least two members.

A system for profiling an organization having members may include a database management system, an associated database, and at least one member station configured to perform one or more of the processes discussed above.

A database structure may contain a set of processes in an organization and a set of characterizations of each process that members of that organization may select to describe the processes that they perform for the organization.

A database structure may contain an identification of members of an organization and, for each member, a set of processes with which the member is involved and, as to at least some of the processes, characterizations of the processes by the members.

A process for profiling the infrastructure of an organization having members may include presenting a user interface to members to a selection database that contains a plurality of processes of the organization and, for each process, a plurality of selectable characterizations of the process. Selections may be received from members through the user interface of one or more of the processes. Selections may also be received from members through the user interface of one or more of the characterizations of the processes that they selected. The selections of the processes and characterizations entered by the members may be stored, along with an identification of the members that made the selections. The stored selections made by the members may be compared with a comparison database containing a model of processes of the organization and, for each process, characterizations of the process. A presentation based on the comparing may be generated.

It is understood that other embodiments will become readily apparent to those skilled in the art from the following detailed description, wherein only exemplary embodiments are shown and discussed. As will be realized, the technology is capable of other and different embodiments and its several details are capable of modification in various other respects, all without departing from its spirit and scope. Accordingly, the drawings and detailed description are to be regarded as illustrative in nature and not as restrictive.

### BRIEF DESCRIPTION OF DRAWINGS

FIG. 1 is a flow diagram of a process for profiling an organization based on selections made by members of that organization from database tables.

FIG. 2 is flow diagram of a process for the Obtaining Selections from Members step in FIG. 1.

FIG. 3 is a flow diagram of a more detailed process for the Obtaining Selections from Members step in FIG. 1 that is based on job functions.

FIG. 4 is a flow diagram of a more detailed process for the Obtain Job Functions step in FIG. 3.

FIG. 5 is a flow diagram of a more detailed process for the Obtain Input/Outputs step in FIG. 3.

FIG. 6 is a flow diagram of a more detailed process for the Obtain Triggers step in FIG. 3.

FIG. 7 illustrates a user interface that may be used to obtain selections from members.

FIG. 8 is a table of characterizations that members have selected about their selected processes.

FIG. 9 is a block diagram of a computer system for profiling an organization based on selections made by members of that organization from database tables.

### DETAILED DESCRIPTION OF ILLUSTRATIVE EMBODIMENTS

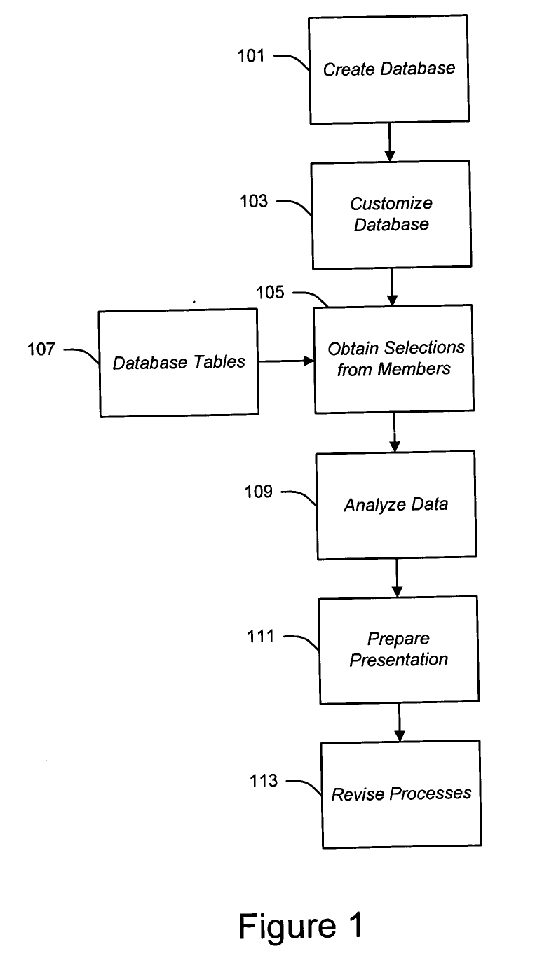

FIG. 1 is a flow diagram of a process for profiling an organization based on selections made by members of that organization from database tables.

As reflected in a Create Database step 101, a database for profiling an organization may be created.

The database may contain a set of processes for an organization. For each process, the database may also contain a set of ways in which a member of the organization may characterize the process.

Examples of the processes and characterizations that might be placed in the database are described below. All of these examples, as well as all other types of processes and characterizations, are also contemplated.

The database itself may take many forms. It may be a relational, hierarchical, or other type of database. It may be a local database, a remote database or a distributed database. It may be contained in a single file or in multiple files. It may be managed by a single database manager or by multiple database managers.

The database that is created in the Create Database step 101 may be a generic database, intended for use in conjunction with a broad variety of organizations, such as businesses, governmental agencies and educational institutions.

Before a generic database is used, a Customize Database step 103 may be performed.

The Customize Database step may be performed by the particular organization that is using the database. The organization may customize the content of the created database to better fit the organization. Certain processes and characterizations in the original database may be removed, while other processes and characterizations may be added.

Processes and characterizations unique to the organization may also be added. For example, the database may be modified in the Customize Database step 103 to define the hierarchies of an organization. The organization that is using the system may be a holding company with subsidiaries, or it may be a business unit of a larger organization. Parent and subsidiary organizations may be specified as they relate to the primary organization. Divisions and departments may also be defined. The same organizational structures can be specified for entities external to the organization, such as customer organizations, suppliers and business partners.

The locations of the various organizations, divisions and departments can also be specified. The specification can be general, such as a city or street address, or it can be more specific, such as a particular floor or section of a building. The exact role of each organization, department or division can also be specified, all using the unique terminology of the organization being profiled.

The members of the organization can also be specified, as well as information about their contacts.

Other types of organization-specific information can also be added.

It is also possible in the Create Database step 101 to create a set of databases, each best suited for a particular type of organization. With this approach, less customization work may be needed during the Customize Database step 103 when an effort is made to customize the generic database to the particulars of a specific organization.

Members of the organization may next select various processes of the organization and their characterizations of those processes during an Obtain Selections from Members step 105. All or some of these selections may be made from database tables 107 in the database.

It is to be understood that references to “members” are intended in their very broadest sense to include employees, consultants, officers, directors, advisors, representatives and all other individuals and companies that are associated, do business or communicate with the organization. Of course, it is also to be understood that the exact scope of the “members” from whom the selections are obtained may be limited to one or more of these groups and/or one or more subsets of these groups.

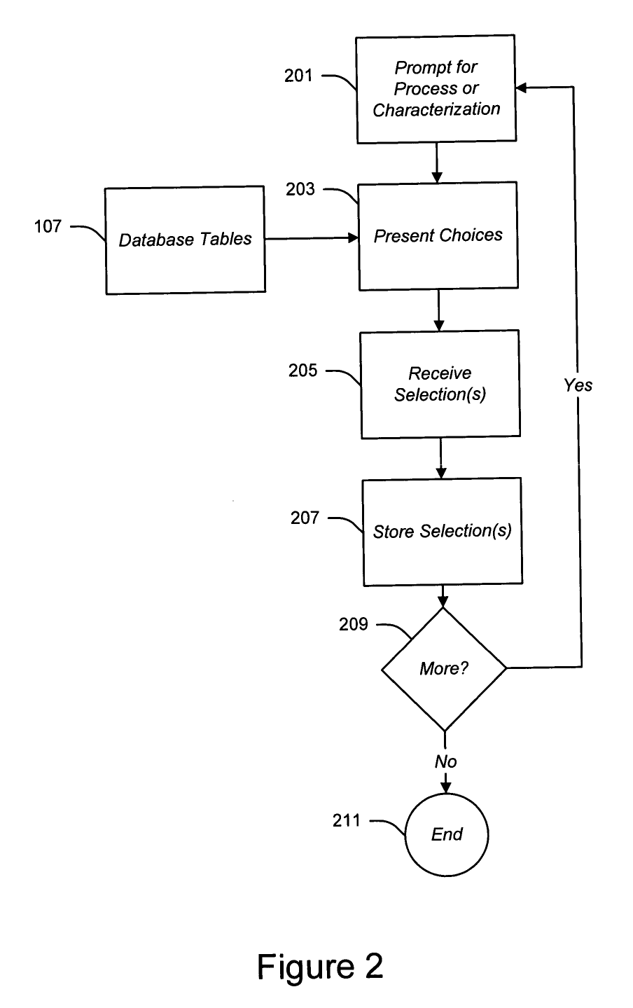

FIG. 2 is a flow diagram of a process for the Obtain Selections from Members step 105 in FIG. 1.

A member may first be prompted to select a process or a characterization of a process, as reflected by a Prompt For Process or Characterization step 201. This may be done by displaying a specific question to the member, by directing the member to make a specific selection, or through any other means.

In response to the prompt, and as reflected by a Present Choices step 203, the member may then be presented with choices to select from one or more database tables 107 in the database.

The member may make one or more selections in response to each prompt.

In some systems or for some prompts, only one selection may be made. For example, a prompt asking for the members name might only permit one selection to be made in response.

In other systems or for other prompts, the member may be able to make multiple selections in response to a single prompt. For example, the prompt may ask the member for the identity of products associated with a particular process.

In still other systems or for other prompts, the system may allow the member to make one or more selections in response to a prompt.

As reflected by a Receive Selection(s) step 205, the selection(s) made by a member may be received. As reflective by a Stored Selection(s) step 207, the received selection(s) may then be stored. The storage of the selection may be in a manner that reflects the identity of the member that made the selection(s) and, in the case of selected characterization(s), the process to which the characterization(s) relate(s). The identity of the member may be stored in a manner that specifically identifies the member or generally identifies the member as associated with a subgroup or associated group of the organization. The identity of the member may also be stored in a manner that allows the specific individual to remain anonymous, if desired.

An inquiry can then be made as to whether there are any more selections that the member needs to make, as reflected by a More? decision step 209. If so, the Prompt 201, Present Choices 203, Receive Selection(s) 205 and Store Selection(s) 207 steps may be repeated, following which the More? decision step 209 may be repeated. Otherwise, the Obtain Selections from Members step 105 may end, as reflected by an End step 211.

Many types of processes and associated characterizations can be used. The exact types will depend in large part upon the type of organization that is being profiled and the type of profiling that is desired.

In one embodiment, in may be desired to profile the business transactions of an organization, including daily operational processes, such as recording sales orders, shipping orders and issuing invoices.

In this embodiment, the processes may be set up to include the various job functions in the organization, while the characterizations may be set up to include the various ways in which members of the organization might characterize their respective job functions.

In this embodiment, the Create Database step 101 and the Customize Database step 103 may include the creation of a list of job functions and, for each, various ways in which those job functions might be characterized by the members that perform them.

The possible characterizations of each process can vary widely. In the job function example, the characterizations might include identification of potential inputs and/or outputs to each job function and, for each input or output, potential triggers for that input or output.

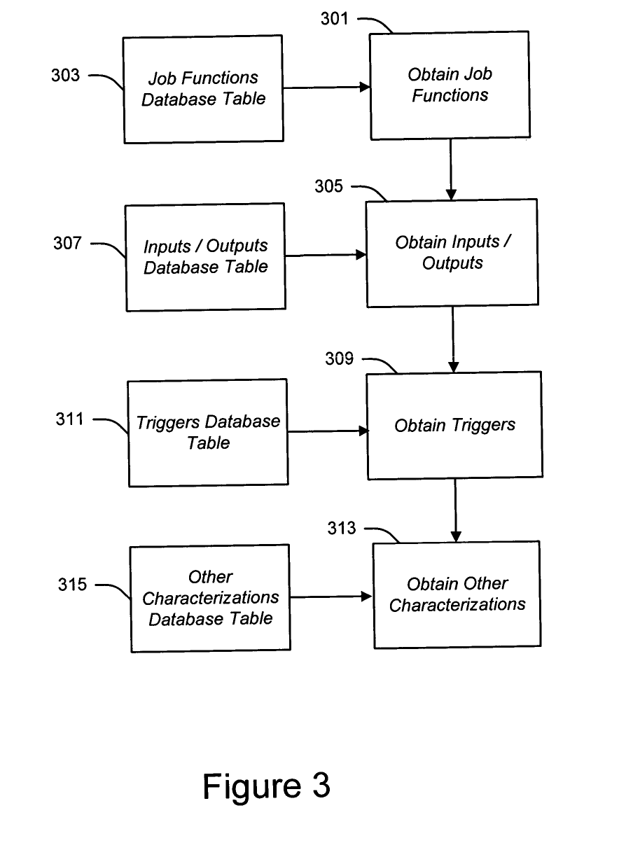

FIG. 3 is a flow diagram of a more detailed process for the Obtaining Selections from Members step 105 in FIG. 1 that is based on job functions.

As reflected by an Obtain Job Functions step 301, the first step may be to obtain from the member a list of the job functions that the member performs. The referenced “obtain” function in this step, as well as others in this application, may include the Prompt 201, Receive Selection(s) 203 and Store Selection(s) 205 steps shown in FIG. 2.

The job functions that the member selects during this step may be extracted from a list of Job Functions Database Table 303 in the database.

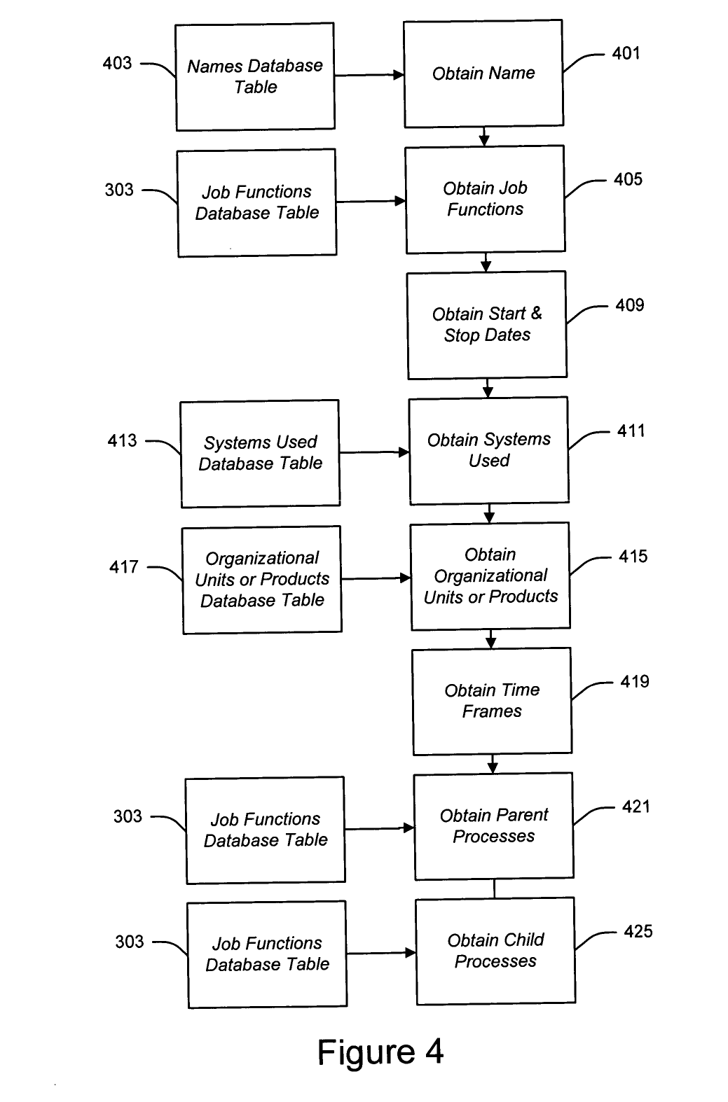

FIG. 4 is a flow diagram of a more detailed process for the Obtain Job Functions step 301 in FIG. 3.

As reflected in an Obtain Name step 401, a list of member names may be presented from a Names Database Table 403, following which the member may select his or her name.

As reflected by an Obtain Job Functions step 405, a list of job functions may then be presented from the Job Functions Database Table 303 to the member, following which the member may select the ones that he or she believes he or she performs.

Each specific job function selected by a member may represent a process in the organization that the member views himself or herself as performing.

The remaining selections that the member makes may represent how the member characterizes each job function process.

As reflected by an Obtain Start & Stop Dates step 409, the member may next enter the date on which the member began or will begin performing each selected job function and/or the date on which the member has or will stop performing each particular job function.

As reflected by an Obtain Systems Used step 411, a member may next select the systems that the member uses in connection with each job function, such as the equipment that the member needs or the written material that he or she must reference. The selections may be derived from a Systems Used Database Table 413.

As reflected by an Obtain Organizational Units or Products step 415, the member may next select the organizations or products that are related to each job function, which may be derived from an Organizational Units or Products Database Table 417.

As reflected by an Obtain Times Frames step 419, the member may next enter the time frames when the member performs each job function.

As reflected by an Obtain Parent Processes step 421, the member may next specify the parent process or processes that precede each job function. The selections may be derived from the Job Functions Database Table 303.

As reflected by an Obtain Child Processes step 425, the member may next specify the child process or processes that follow each job function. The selections may be derived from the Job Functions Database Table 303.

Obtaining parent and child processes can assist the system in later creating a work flow diagram.

Job functions may have inputs and outputs. The input to a job function can be the output from a prior job function; while the output of a job function can be an input to the next job function.

The inputs to an invoicing job function, for example, may include an order from a customer and confirmation that the product has been shipped. The output of this job function may be an invoice mailed to the customer.

Referring again to FIG. 3 and as reflected by an Obtain Inputs/Outputs step 305, the member may next select the inputs and/or outputs that relate to each of his or her job functions. These may be derived from an Inputs/Outputs Database Table 307.

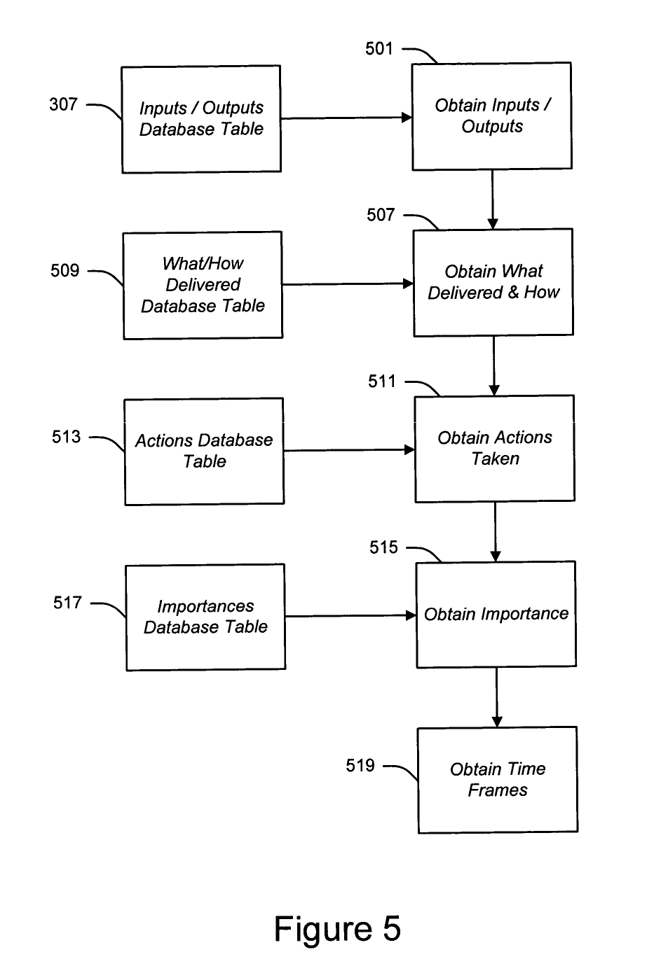

FIG. 5 is a flow diagram of a more detailed process for the Obtain Inputs/Outputs step 305 in FIG. 3.

As shown in FIG. 5, and as reflected in an Obtain Inputs/Outputs step 501, the member may select the inputs and/or outputs of a particular job function from the Inputs/Outputs Database Table 307.

As reflected by an Obtain What Delivered and How step 507, a member may select what is delivered in connection with each input or output and how it is delivered from a What/How Delivered Database Table 509.

As reflected by an Obtain Actions Taken step 511, the member may select what actions the member takes in response to each input or output from an Actions Database Table 513.

As reflected by an Obtain Importance step 515, the member may select the importance of a particular input or output to a particular job function from an Importances Database Table 517.

As reflected by an Obtain Time Frames step 519, a member may enter the time frames during which the member receives each input or provides each output.

Referring back to FIG. 3, and as reflected by an Obtain Triggers step 309, a member may select the triggers for each input/output from a Triggers Database Table 311. A trigger may be what the member perceives as causing the input or output to occur.

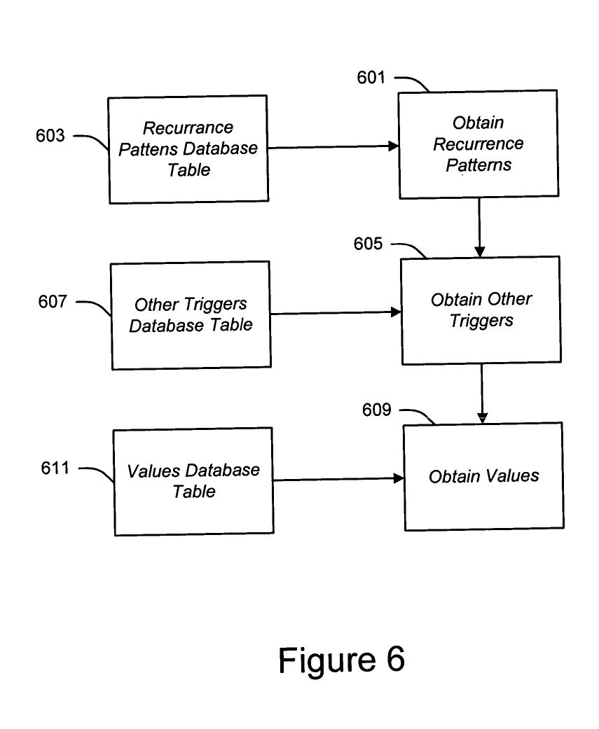

FIG. 6 is a flow diagram of a more detailed process for the Obtain Triggers step 309 in FIG. 3. As shown in FIG. 6, and as reflected by an Obtain Reoccurrence Patterns step 601, a member may select the patterns that are related to a particular input or output from a Reoccurrence Patterns Database Table 603.

As reflected by an Obtain Other Triggers step 605, a member may select other triggers for each input or output from an Other Triggers Database Table 607.

As reflected by an Obtain Values step 609, a member may select the value of a particular trigger from the Values Database Table 611.

Referring again to FIG. 3, and as reflected by an Obtain Other Characterizations step 313, a member may select other characterizations relating to each job function from an Other Characterizations Database Table 315.

The processes that have now been described in connection with FIGS. 3-6 are examples of members selecting processes of an organization, namely job functions that they perform, and their characterizations of these job functions, namely inputs or outputs to each function, the triggers for each input or output, and a broad array of associated information. The exact sequence and nature of these selections, of course, can vary widely.

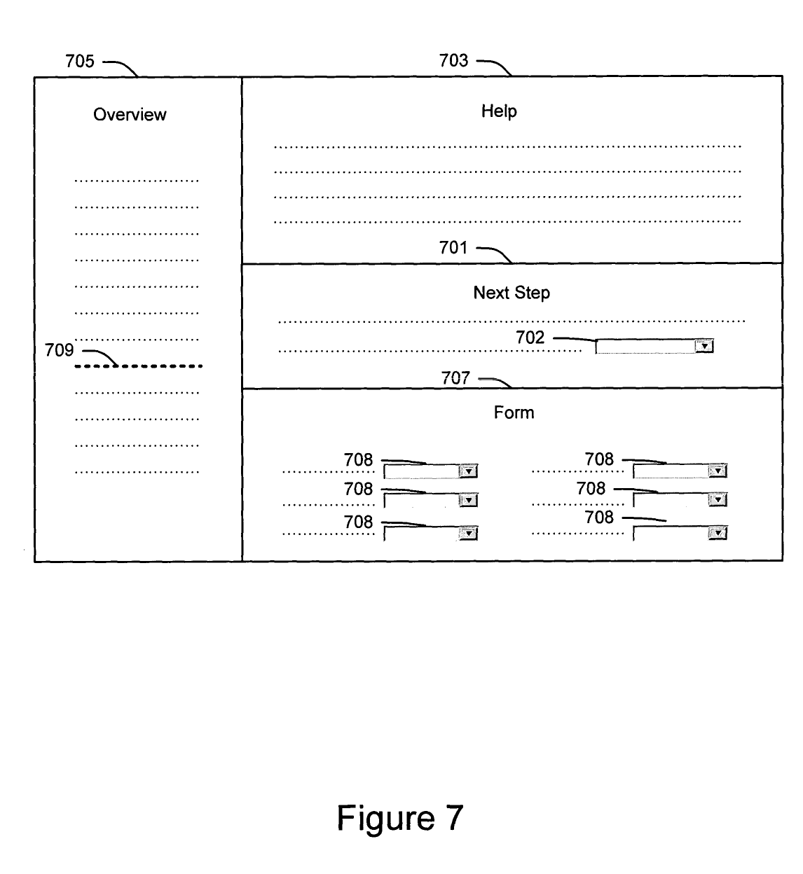

FIG. 7 illustrates a user interface that may be used to obtain selections from members. A Next Step section 701 of the interface may contain the Prompt 201. It may be textual material (indicated in the figure by dotted lines) that may explain to the member the exact nature of the selection that the member needs to make next. The actual selection that the member makes may be made in a drop-down box 702 in the Next Step section that contains the selections.

A Help section 703 may contain textual or other information (indicated in the figure by dotted lines) to provide the member with additional information that may help the member in making the selection that is needed.

After each selection is made, the user interface may increment automatically to a new Prompt 201 in the Next Step section 701, following which the member may make the next selection in the drop-down box 702. Associated changes in the Help section 703 may also be made. The process may repeat until all needed selections are made.

An Overview section 705 may be provided containing line entries (each indicated in the figure by a dotted line). Each line entry may identify a particular selection that the member may make. The selection that the member is currently making, as set forth in the Next Step section 701, may be highlighted in the Overview section 705, such as by the bolding of its associated line entry, e.g., line entry 709.

The Overview section 705 may also be designed to function as a navigation tool, allowing the member to jump to any desired selection by simply clicking on the line entry in the Overview section 705 that corresponds with the desired selection.

A Form section 707 may be provided with drop-down boxes 708 and associated descriptors (indicated in the figure by dotted lines to the left of each drop down box). The Form section 707 may be configured such that the selections made in the drop-down box 702 display in the drop-down box 708 that corresponds with the selection that was made, as signified by the descriptor to the left of the drop-down box 708.

The Form section 707 may also be configured such that the member may make the selections directly in the Form section 707 by making the desired selection in the appropriate drop-down box 708. In this embodiment, the member can thus enter selections in the drop-down box 702 in the Next Step section 701 or in one or more of the drop down boxes 708 in the Form section 707.

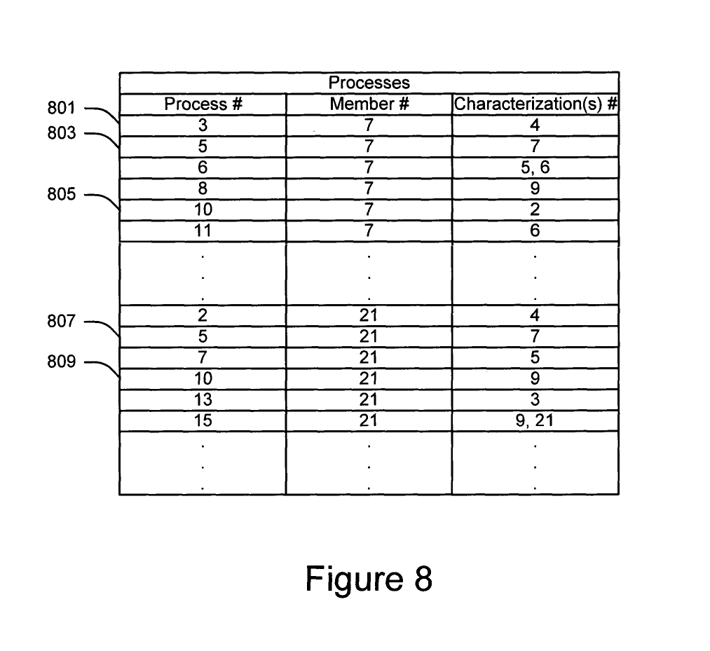

Referring back to FIG. 1, the selections made by the members may then be analyzed, as reflected in an Analyze Data step 109. Examples of the types of analysis that can be done will now be discussed in connection with FIG. 8.

FIG. 8 is a table of characterizations that members have selected about their selected processes. The table is a simplified example of the type of data that can be generated and stored as a result of the selections made by the members.

The first column “Process #” lists the number of processes that were selected by a member. The second column “Member #” lists the number of the member that made that selection. The third column “Characterization(s)” lists the number of the characterization(s) that the member selected for each process.

Row 801 in FIG. 8 reflects that member No. 7 selected process No. 3 and assigned it characterization No. 4. In the business transactions example discussed above, process No. 3 might represent a particular job function that member No. 7 decided that he or she performed for the organization. Characterization 4 may represent a particular characterization of job function No. 3 that member 7 selected, such as an input to that job function.

Of course, different classes of characterizations could be stored in separate fields, rather than storing all of them in a single field as shown in FIG. 8. For example, the inputs the member selects for a particular job function could be listed in one field, while the outputs that the member selects for the particular job function could be listed in a separate field. The triggers to each input or output could similarly be listed in separate fields. The various classes of information could also be contained in separate tables, all related for maximum efficiency.

The processes table in FIG. 8 shows in row 803 that member No. 7 selected process No. 5 and characterized this process with characterization No. 7. This is the same characterization that member No. 21 used for process No. 5 in row 807. Thus, rows 803 and 807 show that members 7 and 21 characterized the same process in the same way. This suggests that process No. 5 is fairly characterized by characterization No. 7.

At the same time, an examination of rows 805 and 809 show that members 7 and 21 characterized process No. 10 in a different way, member No. 7 characterizing it with characterization No. 2, while member No. 21 characterizing it with characterization No. 9. This inconsistency may suggest a misunderstanding of process No. 10 by member No. 7 or by member No. 21 and, in turn, a need to clear up this misunderstanding for better efficiency.

FIG. 8 thus illustrates how two or more members of the same organization may characterize the same process in the same or a different manner. An analysis of the characterizations of the same process by different members can be done and can yield useful information.

Following the analysis, a presentation relating to the analysis may be prepared, as reflected by a Prepare Presentation step 111 in FIG. 1. Such a presentation might include a spreadsheet and/or workflow diagram in electronic and/or paper format.

Based on the presentation and, if desired, based on other information, the processes of the organization may then be revised, as reflected by a Revise Processes step 113. Processes that are determined to be unnecessary may be removed, processes determined to be needed may be added, and processes determined to require change may be changed. Changes in a process may include reassignment of the process to a different member and/or the assignment of the process to additional or fewer members. The sequence of processes may also be modified.

Although having been thus-far described in the context of business transactions, the categorizations of processes and characterizations can also advantageously be used in connection with other processes of the organization, such as processes that develop and manage the infrastructure of an organization. Additional steps may also be employed to assess the value of the infrastructure processes and to modify them accordingly.

Profiling the value of processes (“Value Profiling”) may involve an identification of the components of the infrastructure and an identification of to whom an organization must provide value.

In one embodiment, eight distinct groups may be identified, each with their own types of value. These groups may be Customers/Consumers, Financial Stakeholders, Suppliers, Employees, Alliances/Partners, Unions, Governments/Regulatory Agencies and Society.

The processes in the database may include processes that establish value requirements, processes that deliver and receive value, measurement processes, and processes that manage change.

In this instance, the database that is created during the Create Database step 101 and the Customize Database step 103 may be fashioned in accordance with these goals. If desired, processes may again be defined in terms of job functions and the characterizations of these job functions in terms of inputs and outputs and triggers for these inputs and outputs, much as was discussed above in connection with the profiling of business transactions.

During the Analyze Data step 109, the selections received from members of processes and characterizations of those processes may be compared with a model database of processes of the organization and, for each process, model characterizations of the process. This might be the very same database that was used to produce the selections for the members, or it might be a separate database. During the Prepare Presentation step 111, a presentation might be prepared on the differences between the actual selections and the model database.

For example, the presentation might reveal that certain model processes are not being performed by any member of the organization. It might also reveal that certain processes are being performed by too many members of the organization or by too few. Differences or deficiencies in the characterizations might also be reported.

This information might then be advantageously used in the Revise Processes step 113 to improve the processes of the organization and its infrastructure to deliver better value.

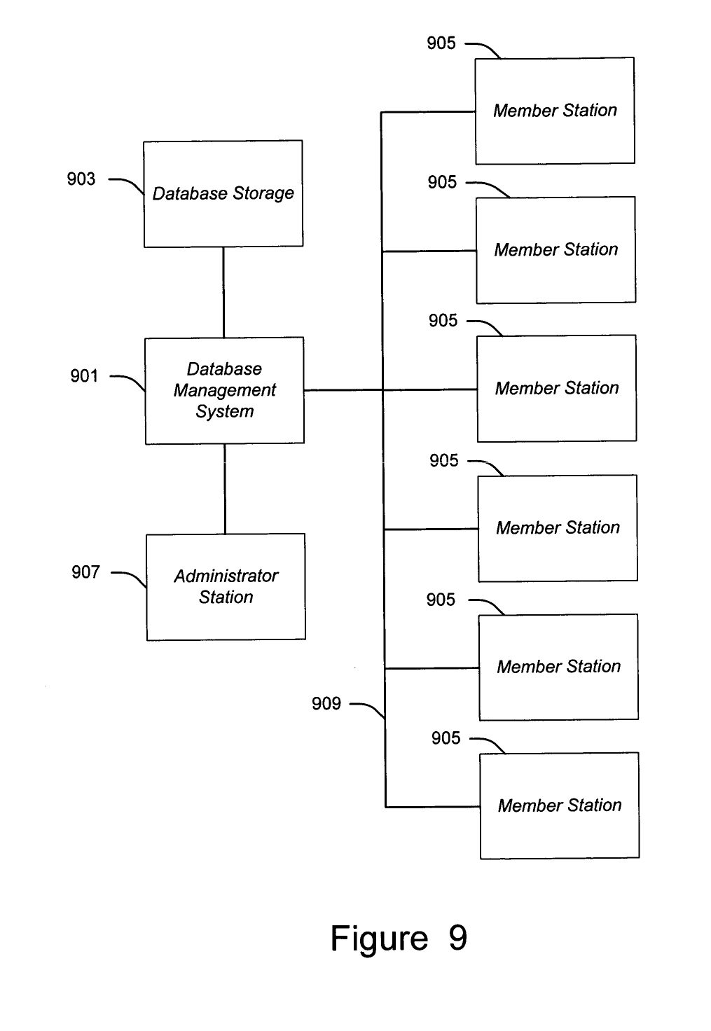

FIG. 9 is a block diagram of a computer system for profiling an organization based on selections made by members of that organization from database tables.

As shown in FIG. 9, a Database Management System 901 may be in communication through a network 909 with Database Storage 903 so as to implement the processes described in connection with FIGS. 1-8 on one or more Member Stations 905. An Administrative Station 907 may also be used.

The Administrative Station 907 may be used in connection with the Create Database step 101, the Customize Database step 103, the Analyze Data step 109, the Prepare Presentation step 111 and/or the Revise Processes step 113.

The Database Storage 903 may be used to store the Database Tables 107, such as the Job Functions Database Table 303, the Inputs/Outputs Database Table 307, the Triggers Database Table 311, the Other Characterizations Database Table 315, the Names Database Table 403, the Systems Used Database Table 413, the Organization Units or Products Database Table 417, the What/How Delivered Database Table 509, the Actions Database Table 513, the Importances Database Table 517, the Recurrence Patterns Database Table 603, the Other Triggers Database Table 607, the Values Database Table 611, and/or the Other Characterizations Database Table 315.

The Member Stations 905 may be used in connection with the Obtained Selections from Members step 105, including the Prompt step 201, the Present Choices 203, the Received Selection(s) step 205, the Store Selection(s) step 207, and all of the steps described and illustrated in connection with FIGS. 3-7.

The exact hardware and software that is used in connection with the Database Management system 901, the Database Storage 903, the Members Stations 905, the Administrative Station 907 and the Network 909 may vary widely from system to system. The Database Storage 903 may be a single storage system or multiple storage systems located together or distributed at different locations. The Database Management System 901 may be a single system at a single location, a single system distributed over multiple locations, or multiple systems at a single or multiple locations.

Although the Administrative Station 907 is illustrated as a single station, it could be multiple stations at the same location or at different locations.

Each Member Station 905 may be located at the desk of a particular member. Alternatively, each Member Station 905 may be located elsewhere. The Member Stations 905 may be at the same location or at different locations. Although several member stations are illustrated in FIG. 9, a single member station could be used and shared by the members.

Any type of network 909 could be used, including a local area network, a wide area network, the Internet, a VPN, a wireless network, or any combination of these. Indeed, all of the subsystems shown in FIG. 9 could be contained and used in a single, stand-alone computer.

Although selections by members have been generally derived from database tables, in certain situations, an appropriate selection might not be present in the table. For example, a table might be missing the name of a particular member, a particular job function of the member, or an appropriate classification of that job function.

In this situation, the user interface may be configured to allow the member to enter his or her name and/or to enter a missing process (e.g., job function) or missing characterization. In this embodiment, the system might then store the new information that the member enters as a new record in the appropriate table of the database. This new record, in turn, might then be available for other members to select, when appropriate.

Although reference has been made to a “database table” in connection with many of the selections that the members may make, several tables may in fact be consulted in connection with a single selection. The database might arrange the selections in a hierarchical structure, particularly when the number selections are numerous. The hierarchical structure might be arranged from very generalized categories of selections at the top of the structure followed by more specific categorizations of the selection as the member travels down various branches of the tree, until arriving at a bottom branch of the tree containing the actual selection that is made and stored.

The user interface may also be configured to adapt to this hierarchical structure and allow the member to make the ultimate selection by traversing through the hierarchical tree. The drop-down box that the interface may present to the user for making the selection, for example, may list the most general descriptions initially. Once the user selects a general description, a sub-menu of more specific descriptions may then be opened, and the process may continue until the user arrives at the bottom of the tree with a specific selection. Such an expanding menu system is a well know element in Windows programming. Other techniques of allowing a member to travel through the tree until he or she reaches a bottom branch may also be used

The characterizations of processes may themselves be presented and stored in a hierarchical fashion. Indeed, such a hierarchical structure is implicit in the discussion above of the example for profiling the business transactions of an organization. At the top of the tree is the identity of the member. Next, is an identification of the processes, e.g., job functions, that each member selects. Each job function, in turn, is related to one or more characterizations, such as inputs or outputs to the job function. Each input or output, in turn, is related to one or more characterizations, such as triggers for the input or output.

Thus, each characterization of a process can be directly related to the process or can be indirectly related through a hierarchical tree of characterizations, as is illustrated above in connection with the example concerning business transactions. Of course, the Analyze Data step 109 would be cognizant of these relationships and would analyze the data with due regard for them.

The description that has now been provided of various embodiments should enable a person of ordinary skill in the art to make and use the technology that is set forth in the claims below. Various modifications of these embodiments will be readily apparent to those skilled in the art, and the general principles defined in this discussion may also be applied to other embodiments, without departing from the spirit or scope of the technology that is set forth in the claims below.

1. A process for profiling an organization having members comprising:
presenting to members a user interface to a database that contains a plurality of processes of the organization and, for each process, a plurality of selectable characterizations of the process;
receiving selections from members through the user interface of one or more of the characterizations of one or more of the processes, including selections of one or more characterizations of the same process by at least two members;
storing the selections of the characterizations made by the members, including the selections of one or more characterizations of the same process by at least two members, along with an identification of the members that made the selections;
comparing the selections made by the members, including the selections of one or more characterizations of the same process by at least two members; and
generating a presentation concerning the selections made by the members, including the selections of one or more characterizations of the same process by at least two members.

2. The process of claim 1 wherein the presentation includes an identification of an inconsistency in the characterizations of the same process by at least two members.

3. The process of claim 1 further including:
receiving selections from members through the user interface of one or more of the processes, including selections of one or more of the same processes by at least two members;
storing the selections of the processes entered by the members, including the selections of one or more of the same processes by at least two members, along with an identification of the members that made the selections.

4. The process of claim 3 wherein at least some of the processes are job functions in the organization.

5. The process of claim 4 further including:
receiving from a member a date when the member began or ended a job function; and
storing the date received.

6. The process of claim 4 wherein at least some of the selectable characterizations of a job function are systems that are used with the job function.

7. The process of claim 4 wherein at least some of the selectable characterizations of a job function are organizations that are involved with the job function.

8. The process of claim 4 wherein at least some of the selectable characterizations of a job function are products or services associated with the function.

9. The process of claim 4 further including receiving from a member a time frame for performing a job function and storing the received time frame.

10. The process of claim 4 wherein at least some of the selectable characterizations of a job function are one or more processes that precede the job function.

11. The process of claim 4 wherein at least some of the selectable characterizations of a job function are inputs to or outputs from the job function.

12. The process of claim 11 wherein at least some of the selectable characterizations of a job function include an identification of what is delivered in connection with an input to or output from the job function.

13. The process of claim 12 wherein what at least some of the selectable characterizations of a job function include a description of how an item is delivered in connection with an input to or an output from the job function.

14. The process of claim 11 wherein at least some of the selectable characterizations of a job function include an identification of what action the member takes in connection with an input to or an output from the job function.

15. The process of claim 11 wherein at least some of the selectable characterizations of a job function include the importance of an input to or an output from the job function.

16. The process of claim 11 wherein at least some of the selectable characterizations of a job function include an identification of what action the member takes in connection with an input to or an output from the job function.

17. The process of claim 11 wherein at least some of the selectable characterizations of a job function include an identification of a time frame for receiving the input to or output from the job function.

18. The process of claim 11 wherein at least some of the selectable characterizations of a job function include a trigger for an input to or output from the job function.

19. The process of claim 1 wherein the user interface prompts the member to make a selection.

20 The process of claim 19 wherein the prompt includes a question.

21. The process of claim 19 wherein the user interface includes a first area for the member to make a selection in response to the prompt.

22. The process of claim 21 wherein the first area includes a drop-down box.

23. The process of claim 21 wherein:
the first areas only allows the member to make a single selection;
the user interface includes a second area for the member to make selections; and
wherein the second areas allows the member to make multiple selections.

24. The process of claim 21 wherein the user interface presents a series of prompts and includes an overview area that visually illustrates the location of the current prompt in the series of prompts.

25. The process of claim 24 wherein the member alters the sequence of prompts by selecting an item in the overview area other than the current prompt.

26. The process of claim 1 wherein the user interface is presented to different members on different computers.

27. The process of claim 1 wherein at least some of the characterizations are arranged in a hierarchical format from general to specific and where members select characterizations by navigating through the hierarchical format from general to specific.

28. The process of claim 1 wherein only a single characterization may be selected for a single process.

29. The process of claim 1 wherein a plurality of characterizations may be selected for a single process.

30. A process for profiling an organization having members comprising:
presenting a user interface to members to a database that contains a plurality of processes of the organization and, for each process, a plurality of selectable characterizations of the process;
receiving selections from members through the user interface of one or more of the characterizations of one or more of the processes, including selections of one or more characterizations of the same process by at least two members; and
storing the selections of the characterizations made by the members, including the selections of one or more characterizations of the same process by at least two members, along with an identification of the members that made the selections.

31. A system for profiling an organization having members comprising a database management system, an associated database, and at least one member station configured to:
present to members a user interface to a database that contains a plurality of processes of the organization and, for each process, a plurality of selectable characterizations of the process;
receive selections from members through the user interface of one or more of the characterizations of one or more of the processes, including selections of one or more characterizations of the same process by at least two members;
store the selections of the characterizations made by the members, including the selections of one or more characterizations of the same process by at least two members, along with an identification of the members that made the selections;
compare the selections made by the members, including the selections of one or more characterizations of the same process by at least two members; and
generate a presentation concerning the selections made by the members, including the selections of one or more characterizations of the same process by at least two members.

32. A system for profiling an organization having members comprising a database management system, an associated database, and at least one member station configured to:
present to members a user interface to a database that contains a plurality of processes of the organization and, for each process, a plurality of selectable characterizations of the process;
receive selections from members through the user interface of one or more of the characterizations of one or more of the processes, including selections of one or more characterizations of the same process by at least two members; and
store the selections of the characterizations made by the members, including the selections of one or more characterizations of the same process by at least two members, along with an identification of the members that made the selections.

33. A database structure containing a set of processes in an organization and a set of characterizations of each process that members of that organization may select to describe the processes that they perform for the organization.

34. The database structure of claim 33 wherein the processes include job functions.

35. The database structure of claim 34 wherein the characterizations include inputs to or outputs from the job functions.

36. The database structure of claim 35 wherein the characterizations include triggers for the inputs to or outputs from job functions.

37. A database structure containing an identification of members of an organization and, for each member, a set of processes with which the member is involved and, as to at least some of the processes, characterizations of the processes by the members.

38. The database structure of claim 37 wherein the processes include job functions.

39. The database structure of claim 38 wherein the characterizations include inputs to or outputs from the job functions.

40. The database structure of claim 39 wherein the characterizations include triggers for the inputs to or outputs from job functions.

41. A process for profiling the infrastructure of an organization having members comprising:
presenting to members a user interface to a selection database that contains a plurality of processes of the organization and, for each process, a plurality of selectable characterizations of the process;
receiving selections from members through the user interface of one or more of the processes;
receiving selections from members through the user interface of one or more of the characterizations of the processes that they selected;
storing the selections of the processes and characterizations entered by the members along with an identification of the members that made the selections.
comparing the stored selections made by the members with a comparison database containing a model of processes of the organization and, for each process, characterizations of the process; and
generating a presentation based on the comparing.

42. The process of claim 41 wherein the presentation includes an identification of an inconsistency between the stored selections and the model.
